(19) United States
(12) Patent Application Publication
(10) Pub. No.: US 2010/0205374 A1
(43) Pub. Date: Aug. 12, 2010

(54) EMBEDDED SYSTEM FOR MANAGING DYNAMIC MEMORY AND METHODS OF DYNAMIC MEMORY MANAGEMENT

(75) Inventors: Venkata Rama Krishna Meka, Gyeonggi-do (KR); Ji-Sung Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/699,698

(22) Filed: Feb. 3, 2010

(30) Foreign Application Priority Data
Feb. 11, 2009 (KR) 10-2009-0011228

(51) Int. Cl. G06F 12/02; G06F 12/08

(52) U.S. Cl. 711/117; 711/E12.002; 711/173; 711/171; 711/E12.016

(57) ABSTRACT

A dynamic memory management method suitable for a memory allocation request of various applications can include predicting whether an object for which memory allocation is requested is a short-lived first type object or a long-lived second type object by using index information relating to the size of the object; determining whether a heap memory includes a free block that is to be allocated to the object by using a plurality of free lists that are classified as a plurality of hierarchical levels; and allocating the free block to the object if the heap memory is determined to include the free block, wherein, if the object is predicted to be the first type object, the free block is allocated to the object in a first direction in the heap memory, and, if the object is predicted to be the second type object, the free block is allocated to the object in a second direction in the heap memory.

### CROSS-REFERENCE TO RELATED APPLICATIONS

This application claims priority under 35 U.S.C. §119 to Korean Patent Application No. 10-2009-0011228, filed on Feb. 11, 2009, in the Korean Intellectual Property Office, the disclosure of which is incorporated herein in its entirety by reference.

### BACKGROUND

Various embodiments relate to an embedded system including a memory managing unit, and more particularly, to an embedded system including a memory managing unit that dynamically allocates memory.

Memory management can directly affect the performance of an embedded system including a microprocessor. The memory management allocates portions of memory of the embedded system and frees the allocated portions of memory with respect to each application in order to generally execute various applications in the microprocessor. Memory allocation operations are classified into static memory allocation operations and dynamic memory allocation operations.

A static memory allocation operation uses a fixed amount of memory. In some instances, however, a relatively large fixed amount of memory causes unnecessary consumption of memory in the embedded system. Thus, an embedded system that has a limited amount of memory needs dynamic memory allocation with respect to various applications.

Dynamic memory allocation can allocate memory from a heap of unused memory blocks. A variety of algorithms have been used to more efficiently perform dynamic memory allocation. How fast a free block (a block allocated in response to a memory request) is searched and how efficiently dynamic memory allocation is performed may be important in order to realize the algorithms. For example, a plurality of free blocks may be managed by using a single free list, and a variety of memory allocation policies, such as first-fit, next-fit, best-fit, and the like, may be used to search for the single free list. Otherwise, a plurality of free blocks may be managed by using a segregated free list. In this case, one of a plurality of free lists may be selected according to information about the size of an object for which memory allocation is requested, and the selected free list is searched, thereby allocating a memory block having an appropriate size to the object.

The variety of allocation algorithms used to dynamically allocate memory does not wholly meet requirements of various applications. In more detail, various applications require different memory sizes and request patterns, and optimally use different allocation algorithms. In particular, although efficient memory management requires a reduction in memory fragmentation and improvement of local property, various allocation algorithms sometimes do not satisfy such requests.

### SUMMARY

According to an aspect of the inventive concept, there is provided a method of managing a dynamic memory, the method including: predicting whether an object for which memory allocation is requested is a short-lived first type object or a long-lived second type object by using index information relating to the size of the object; determining whether a heap memory includes a free block that is to be allocated to the object by using a plurality of free lists that are classified as a plurality of hierarchical levels; and allocating the free block to the object if the heap memory is determined to include the free block, wherein, if the object is predicted to be the first type object, the free block is allocated to the object in a first direction in the heap memory, and, if the object is predicted to be the second type object, the free block is allocated to the object in a second direction in the heap memory.

The plurality of free lists may be classified as a plurality of free list classes having relatively large sizes, where each free list class is divided into a plurality of free list sets having relatively small sizes, and each free list set is further divided into a plurality of free list ways used to allocate the free block to the first type object or the second type object.

Predicting the type of the object may be performed by using a prediction mask including bit information about an object type of each free list class, and wherein the determining of whether the heap memory includes the free block is performed by using a first level mask including bit information indicating whether each free list class includes an available free block, a second level mask including bit information indicating whether each free list set includes an available free block, and a third level mask including bit information indicating whether each free list way includes an available free block.

The method may further include: if the free list class or free list set is determined not to include the free block, performing memory allocation by determining whether a higher free list class or free list set than that corresponding to the object includes the free block and/or determining whether the free block is included in a region of the heap memory that is allocated to a different type of an object from the predicted type of the object.

The method may further include: de-allocating the memory with regard to the object in response to a memory de-allocation request with regard to the object, wherein de-allocating the memory comprises: updating the bit information of the first level mask through the third level mask based on information about the size and type of the block for which de-allocation is requested; and detecting the number of other blocks for which memory allocation is performed between the memory allocation and de-allocation in order to determine the lifespan of the block and updating the prediction mask based on a result of detection.

The method may further include: splitting the free block into multiple free blocks when the size of the free block exceeds the size of the object for which memory allocation is requested.

The method may further include: separating a memory allocation request for memory smaller than a predetermined size from other memory requests.

According to another aspect of the inventive concept, there is provided a method of managing a dynamic memory, the method including: determining whether a heap memory that is divided virtually into a plurality of regions includes a free block that is allocated to an object by using a plurality of free lists that are classified as a plurality of hierarchical levels based on sizes of a plurality of free blocks; dividing a lower hierarchical level of the plurality of hierarchical levels into a plurality of free list ways corresponding to the number of the plurality of regions of the heap memory, and selecting one of the free list ways by using at least one status mask including information about a recently allocated region among the plurality of regions of the heap memory; and if the selected free list way includes an available free block, allocating a corresponding region of the heap memory to the object.

According to another aspect of the inventive concept, there is provided a embedded system that dynamically allocates memory in response to a memory allocation request, the embedded system including: an embedded processor controlling an operation of the embedded system, and comprising a memory managing unit controlling dynamic memory allocation in response to the memory allocation request of an application; and a memory unit allocating memory to an object for which memory allocation is requested under the control of the embedded processor, wherein the memory managing unit determines whether the memory unit includes a free block that is allocated to the object by using a plurality of free lists that are classified as a plurality of hierarchical levels based on sizes of a plurality of free blocks.

### BRIEF DESCRIPTION OF THE DRAWINGS

Various embodiments of the inventive concept will be more clearly understood from the following detailed description taken in conjunction with the accompanying drawings in which:

FIG. 1 is a block diagram of an embedded system according to an embodiment of the present invention;

FIG. 2 illustrates a memory unit shown in FIG. 1 according to an embodiment of the present invention;

FIG. 3 illustrates various bit masks used to manage memory according to an embodiment of the present invention;

FIGS. 4A, B illustrate lookup tables and a prediction mask according to an embodiment of the present invention;

FIG. 5 illustrates memory allocation operations performed with regard to first and second type objects in a heap memory according to an embodiment of the present invention;

FIG. 6 is a flowchart illustrating a memory allocation operation performed by the embedded system shown in FIG. 5, according to an embodiment of the present invention;

FIG. 7 is a flowchart illustrating a memory de-allocation operation according to an embodiment of the present invention;

FIG. 8A illustrates the bitmasks and free-lists organization in an embedded system according to another embodiment of the present invention; and FIG. 8B illustrates a heap memory organization according to another embodiment of the present invention;

FIG. 9 is a flowchart illustrating a memory allocation operation performed by the embedded system shown in FIGS. 8A and 8B according to an embodiment of the present invention.

### DETAILED DESCRIPTION OF THE EMBODIMENTS

Various example embodiments will now be described more fully with reference to the accompanying drawings, in which some example embodiments are shown. The present invention may, however, be embodied in many different forms and should not be construed as being limited to the example embodiments set forth herein. Rather, these example embodiments are provided so that this disclosure is thorough and complete, and will fully convey the scope of the present invention to those skilled in the art. Like reference numerals in the drawings denote like elements throughout, and thus their descriptions will be omitted.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In light of a dynamic memory allocation policy performed by an embedded system according to an embodiment of the present invention, a memory managing unit included in the embedded system receives a memory allocation request with regard to an object from an application and predicts whether the object is short-lived or long-lived. In the embodiments described below, a short-lived object and a long-lived object are defined as a first type object and a second type object, respectively.

According to the result of the prediction of the lifespan of the object, the memory managing unit performs different memory allocation operations with regard to the first type object and the second type object. For example, if the application requests memory allocation for the first type object, the memory managing unit may allocate memory to the first type object from the bottom of a heap memory to the top thereof, and, if the application requests memory allocation for the second type object, the memory managing unit may allocate memory to the second type object from the top of the heap memory to the bottom thereof, or vice versa.

In general, various applications request memory allocation for small size and large size objects. The small size objects are most likely a first type objects. If a single heap memory is used for all the requested objects without determining whether the object is the first type object or the second type object, in particular, memory fragmentation may increase due to the first type objects. Thus, according to an embodiment of the present invention, memory allocation is performed with regard to the first type object and the second type object in different directions, thereby reducing the memory fragmentation. Various applications request allocation of different sizes of memory. Objects for which memory allocation is requested have different lifespans. If the memory requirements and average life-span of the objects were known, using a special chunk of memory for short-lived objects would solve the problem. However, the memory requirements of the recent applications like multimedia streaming and wireless applications are unpredictable and moreover, the average memory requirement varies widely from one configuration to another. Hence, using a special memory chunk for worst case memory requirements would lead to high overhead in memory space. Thus, in the present invention, it is predicted whether the requested object is the first type object or the second type object, and memory allocation (or de-allocation) is performed within a predetermined period of time. The memory allocation operation reduces memory fragmentation and maintains spatial locality.

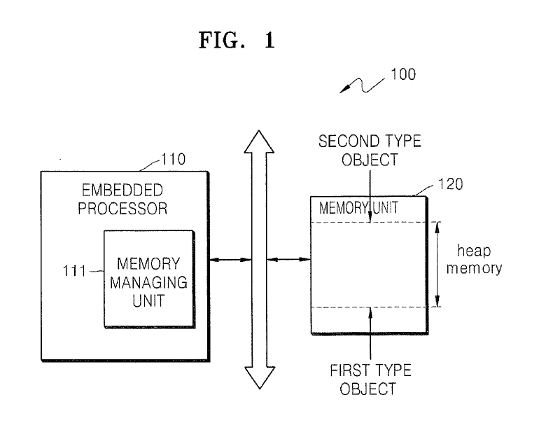

FIG. 1 is a block diagram of an embedded system 100 according to an embodiment of the present invention. Referring to FIG. 1, the embedded system 100 may include an embedded processor 110 that controls a general operation of the embedded system 100 and includes an operating system (OS), and a memory unit 120 that is controlled by the embedded processor 110 and stores various commands and various pieces of data used to operate the embedded system 100. The embedded processor 110 may further include a memory managing unit 111 that controls a memory allocation and free operation performed by the memory unit 120. The memory unit 120 may include a heap memory that is used to dynamically allocate memory in response to a memory request of an application.

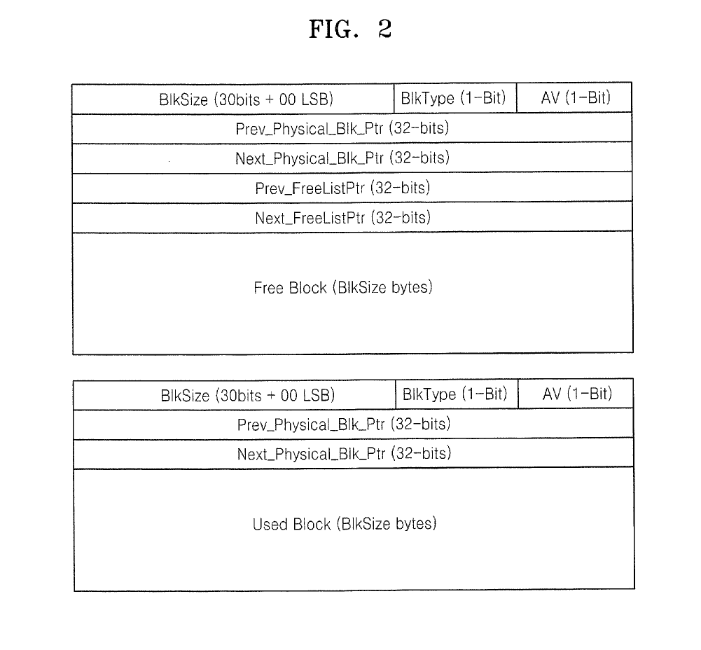

FIG. 2 illustrates the memory unit shown 120 in FIG. 1 according to an embodiment of the present invention. Referring to FIG. 2, the memory unit 120 may include a free block that is to be allocated according a request of an application and a used block that was allocated to a predetermined application. The free block and the used block may include header information that is various pieces of information (used status, block type, and block size) about the free block and the used block, respectively. For example, the header information may include flag information such as AV and BlkType. The flag information AV indicates whether a corresponding block is the free block or the used block. The flag information BlkType indicates a type of the free block or the used block. The header information may include at least one word indicating the Blksize of the free block or the used block. Since memory unit sizes are rounded to multiples of 4 bytes, the lower two bits of the Blksize info will be always zero. Hence, in the header, upper 30 bits are used for Blksize info and lower 2 bits are used for flag info.

The free block and the used block have, respectively, various pieces of pointer information, in addition to the header information. For example, the free block may include pointer information Prev_Physical_BlkPtr, Next_Physical_BlkPtr indicating whether physically adjacent blocks are free blocks or used blocks, and another piece of pointer information Prev_FreeListPtr, Next_FreeListPtr indicating positions of previous and next free blocks in a free list. Meanwhile, the used block may include pointer information Prev_Physical_BlkPtr, Next_Physical_BlkPtr indicating status of the physically adjacent blocks. However, since the used block is deleted from the free list, the used block need not include the pointer information Prev_FreeListPtr, Next_FreeListPtr indicating positions of previous and next free blocks. The pointer information is required to coalesce the physically adjacent blocks or manage free blocks by using the free list.

A plurality of free lists is used to perform memory management (memory allocation or memory free (cancellation of memory allocation)) in the present embodiment. Each free list has a similar size within a predetermined range and manages specific (first or second) type free blocks. In particular, in the present embodiment, the free lists are classified as a plurality of hierarchical levels (e.g., three hierarchical levels) in order to separate and manage first type blocks that are allocated first type objects and second type blocks that are allocated second type objects. For example, the free lists may be classified as a plurality of free list classes (e.g., 32 free list classes). The free lists classified as the free list classes may be used to manage free blocks having sizes that increase by multiplication of 2. For example, free lists included in an N^{th} free list class may be used to manage free blocks having sizes between and 2^{N} and 2^{N+1}−1 and free lists included in an N+1^{st} free list class adjacent to the N^{th} free list class may be used to manage free blocks having sizes between 2^{N+1} and 2^{N+2}−1.

Each free list class may be divided into two or more different free list sets. In more detail, the free list classes may be used to determine a relatively wide range of free blocks, and free list sets may be used to determine a relatively short range of free blocks in a corresponding free list class. Thereafter, each free list set is further divided into two or more free list ways. That is, each free list set may be divided into a first free list way and a second free list way, free lists corresponding to the first free list way manage first type free blocks, and free lists corresponding to the second free list way manage second type free blocks.

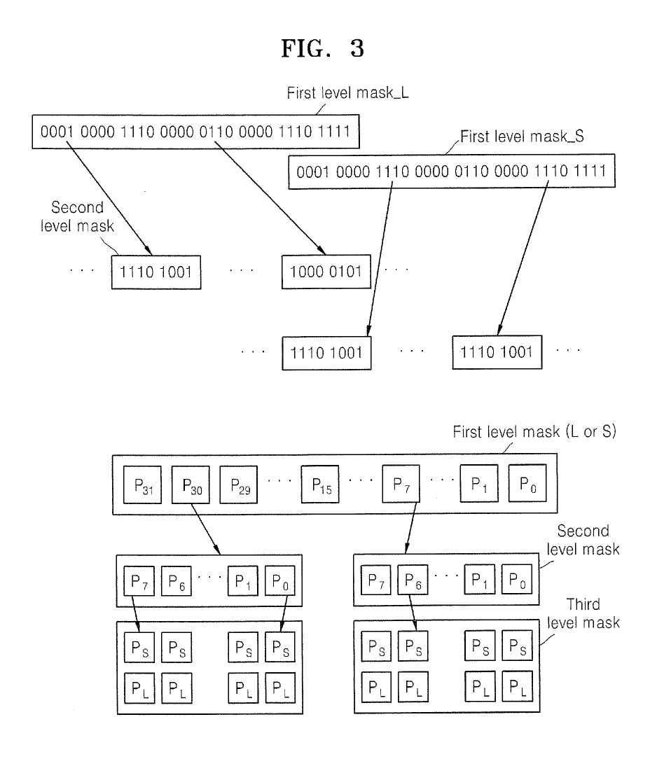

FIG. 3 illustrates various bit masks used to manage memory according to an embodiment of the present invention. Referring to FIG. 3, bit masks are used to predict whether a corresponding free list class or a corresponding free list set includes free blocks. Two first level masks may each have 32 bit information. One first level mask S indicates the availability of first type free blocks. The other first level mask L indicates the availability of second type free blocks. As described with regard to FIG. 2, free lists included in the embedded system 100 may be classified as a plurality of free list classes. For example, if free lists are classified as 32 free list classes, each of the 32 bits included in the two first level masks indicates information about whether each free list class includes available free blocks.

Each free list class is divided into a plurality of free list sets. The memory managing unit 111 includes a plurality of second level masks in order to predict whether each free list set includes available free blocks. For example, if each free list class is divided into 8 free list sets, second level masks having 8 bits may correspond to each bit of one of the two first level masks. If the two first level masks have 32 bits, 64 second level masks of 8 bits may be included in the memory managing unit 111. In this case, the free lists that are classified as 32 free list classes are divided into 8 free list sets per each free list class. Bits of each second level mask indicate information about whether each free list set includes available free blocks.

Meanwhile, each free list set may be divided into a first free list way corresponding to a first type and a second free list way corresponding to a second type. A third level mask indicates information about whether each free list way includes available free blocks.

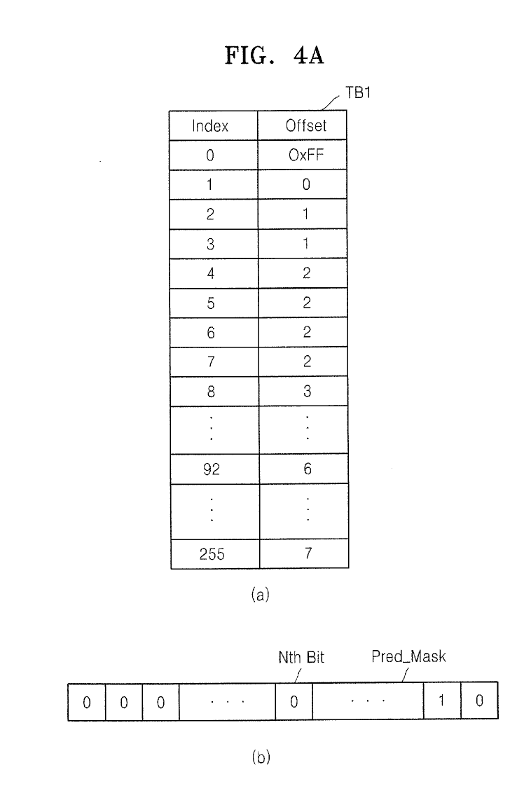

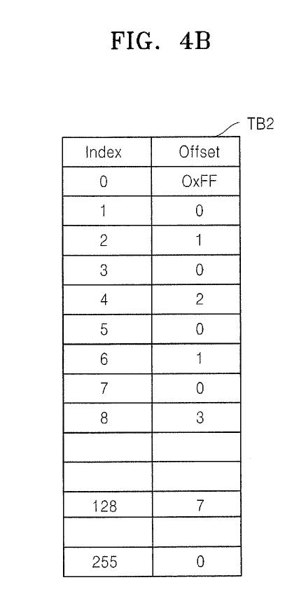

FIGS. 4A, 4B illustrate lookup tables TB1 and TB2 that are employed to speedup the first level index and second level index calculations, and a prediction mask Pred_Mask used to predict whether an object is a first type object or a second type object by using the first level index according to an embodiment of the present invention. Referring to FIG. 4A, if the memory managing unit 111 receives a memory allocation request with regard to the object, the memory managing unit 111 calculates the first level index by using information about the size of the object and the lookup table TB1. The lookup table TB1 provides a position value of a most significant bit (MSB) having a value “1” in the block size (for example, if the size of the object is between 2^{N} and 2^{N+1}−1, the first level index is N). The lookup table TB1 can be used to quickly calculate the first level index without a bit search operation such as a predetermined log operation. The first level index may be calculated by using algorithm below.

[Algorithm 1]

```
BitShift = 24;
Byte = BlkSize >> BitShift;
first-level-index = LTB1[Byte];
While(first-level-index == 0xFF){
    BitShift += −8;
Byte = (BlkSize >> BitShift) && 0XFF;
    first-level-index = LTB1[Byte];
    }
    first-level-index += BitShift;
N = first-level-index;
```

If the memory managing unit 111 calculates the first level index, the prediction mask Pred_Mask predicts whether the object for which memory allocation is requested is the first type object or the second type object. For example, if the memory managing unit 111 calculates the value of the first level index as N, a value of an N^{th} bit of the prediction mask Pred_Mask is calculated. If the value of the N^{th} bit of the prediction mask Pred_Mask is 1, the object for which memory allocation is requested is determined as the first type object, and, if the value of the N^{th} bit of the prediction mask Pred_Mask is 0, the object for which memory allocation is requested is predicted as the second type object.

The prediction mask Pred_Mask is initially established to have a predetermined value and predicts whether the object for which memory allocation is requested is the first type object or the second type object. In the present embodiment, the prediction mask Pred_Mask is updated whenever some block is freed. When a block is freed, the lifespan of the block may be determined and a corresponding bit value of the prediction mask Pred_Mask may be updated based on the determined lifespan. The lifespan of a block may be determined based on how many other blocks have been allocated between the allocation of blocks and the cancellation of the allocation. The memory managing unit 111 predicts whether the block is a first type block or a second type block statistically when some block is freed, and updates the prediction mask Pred_Mask to have a bit value 1 or 0 corresponding to the block according to the result of the determination.

For example, the prediction mask Pred_Mask may include bit information of each free list class and it is used by the managing unit 111 to predict whether the object is the first type object or the second type object according to a class including the object for which memory allocation is requested. Thus, when the free lists are classified as 32 free list classes, the prediction mask Pred_Mask includes 32 bit information. If the prediction mask is initially established to have a decimal value of 1023, then the 10 lower bits of the prediction mask Pred_Mask have a binary value of 1. During initial memory allocation, if the first level index is 4 based on the size of the object for which memory allocation is requested, the managing unit 111 predicts the object as the first type object.

As described above, the size of the object for which memory allocation is requested and the lookup table TB1 are used to predict the type of the object and determine one of a plurality of free list classes. If the type of the object is predicted as the first type object, the first level mask S is used for the first type object. It is then determined whether the decided free list class includes available free blocks according to bit information of the first level mask S used for the first type object. Alternatively, if the type of the object is predicted as the second type object, the first level mask L is used for the second type object. It is then determined whether the decided free list class includes available free blocks according to the bit information of the first level mask L used for the second type object.

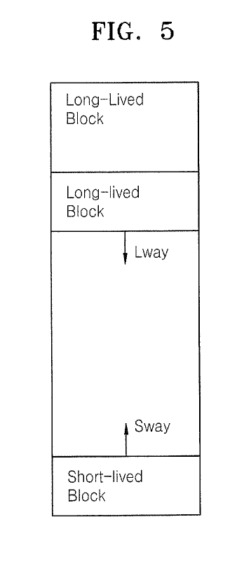

FIG. 5 illustrates different memory allocation operations performed with regard to first and second type objects in a heap memory according to an embodiment of the present invention. Referring to FIG. 5, the heap memory that may be included in the memory unit 120 may include a first type block used to store the first type object and a second type block used to store the second type object. For example, the heap memory having the size of 200 bytes may include a 100 byte portion for the first type object and another 100 byte portion for the second type object. Then, in response to an allocation request with respect to an 8 byte object (that is assumed to be the first type object), a memory block may be allocated to the 8 byte object from the bottom of the heap memory to the top thereof, and in response to an allocation request with respect to a 32 byte object (that is assumed to be the second type object), the memory block may be allocated to the 32 byte object from the top of the heap memory to the bottom thereof, or vice versa.

As described above, the heap memory is divided into portions for allocating the first type object and the second type object, thereby easily adjusting a boundary of the heap memory according to the type of an object. For example, if a large free block that is to be allocated to the first type object exists on the boundary of the heap memory, whereas a portion that is to be allocated to the second type object is insufficient thereon, the large free block is divided into a plurality (e.g. 2) of free blocks, and one of the divided free blocks is provided as a memory portion for the second type object. Therefore, the sizes of portions allocated to the first type object and the second type object may be adjusted in the heap memory.

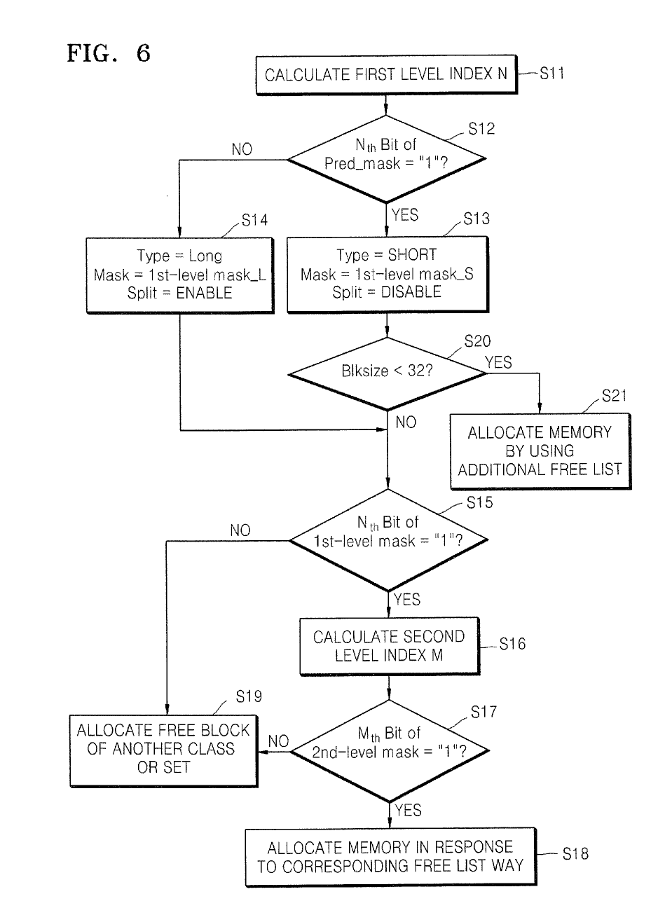

FIG. 6 is a flowchart illustrating a memory allocation operation according to an embodiment of the present invention. Referring to FIG. 6, in operation S11, a first level index is calculated corresponding to a position of an initial non-zero (e.g., a bit value of 1) representation of the size of an object for which memory allocation is requested.

After the first level index is calculated, operation S12 determines whether the object for which memory allocation is requested is a first type object or a second type object by using a bit value of a prediction mask corresponding to the first level index. According to the bit value of the prediction mask, either a first level mask S for the first type object is initialized in operation S13 or another first level mask L for the second type object is initialized in operation S14.

Using the first level index N, operation S15 determines whether the N^{th} class includes an available free block based on the value of the N^{th} bit of the first level mask. If the N^{th} class includes the available free block, a second level index is calculated in operation S16 from information about the size of the object for which memory allocation is requested. The second level index may have a value of a predetermined number of bits positioned right from a MSB having an initial value 1, among values of bits corresponding to the size of the object for which memory allocation is requested. For example, if each free list class includes 2̂k free list sets, the second level index may have a value of k bits included in the size of the object for which memory allocation is requested.

After the second level index is calculated, operation S17 determines whether a corresponding set includes an available free block by using the second level index and a second level mask. A free list set is divided into two or more free list ways. For example, a free list set may be divided into a first free list way Sway corresponding to the first type object and a second free list way LWay corresponding to the second type object. If a corresponding free list set includes the available free block, one of the first and second free list ways, SWay and LWay, respectively, is selected based on the predicted block type. In operation S18, the object for which memory allocation is requested is allocated by using a top free block from the first free list way Sway or is allocated by using a top free block from the second free list way LWay.

The memory managing unit 111 determines whether to split the available free block into two (or more) free blocks when the size of the chosen free block is greater than that of the object for which memory allocation is requested based on a predetermined split flag. For example, as described with reference to operations S13 and S14, when the object for which memory allocation is requested is the first type object, an operation of splitting a free block corresponding to the first type object may be disabled. Meanwhile, when the object for which memory allocation is requested is the second type object allocated to a free block having a relatively great size, the operation may be enabled.

In operation S19, when the N^{th} class does not include the available free block or free list sets included in the N^{th} class do not include the available free block, free blocks included in another class or set may be allocated to the object for which memory allocation is requested. Various methods may be used to perform operation S19.

For example, the first level index can be greater than an initial value N. In such an instance, the first level index has a position value of a bit that is positioned higher than an Nth bit and has the value (1) of the non-zero bit in the first level mask. In this case, the second level index may be established to be 0. In more detail, since reestablishment of the first level index results in a selection of a higher free list class, the second level index may be 0 in order to select a free list set included in the higher free list class. A lookup table TB2 shown in FIG. 4B may be used to reestablish the first level index. The first level index and the second level index may be reestablished by using algorithm below.

[Algorithm 2]

```
first-level-index++;
Mask = FirstLevMask >> first-level-index
Temp = LTb2[Mask & 0xFF]
while(Temp == 0xFF){
    Mask = Mask >> 8;
if(Mask == 0){
//Out of memory. get new memory block from OS.
}
  Temp = LTb2[Mask & 0xFF];
  first-level-index += 8;
}
second-level-index = LTb2[SecondLevMask[first-level-index]];
```

Similarly, if a predetermined free list set (e.g., an M^{th} free list set) does not include the available free block, the second level index may be established to be greater than M. Such reestablishment may be performed similarly to the reestablishment of the first level index. In more detail, if a free list set does not include the available free block, an available block that is included in a higher free list set may be allocated.

In a special case, if the object for which memory allocation is requested is the first type object and the N^{th} class does not include the available first type block, it may be determined whether the N^{th} class includes an available second type block by using the first level mask L corresponding to the second type object. If the N^{th} class includes the available second type block, the first level index may be established to be an initial value (e.g., N), and the object for which memory allocation is requested may be determined as the second type object. Thus, small free blocks may be efficiently used.

A memory allocation request for memory smaller than a predetermined number of bytes (e.g., 32 bytes) may be separate from another memory allocation request. For example, in operation S20, free lists that are separated from previously mentioned free lists may be used to process the memory allocation request for the memory smaller than 32 bytes. The free lists that are separated from the previously mentioned free list may be indexed by a simple bit shift operation. If the size of the object for which memory allocation is requested is smaller than 32 bytes, in operation S21, different free lists may be used to perform memory allocation.

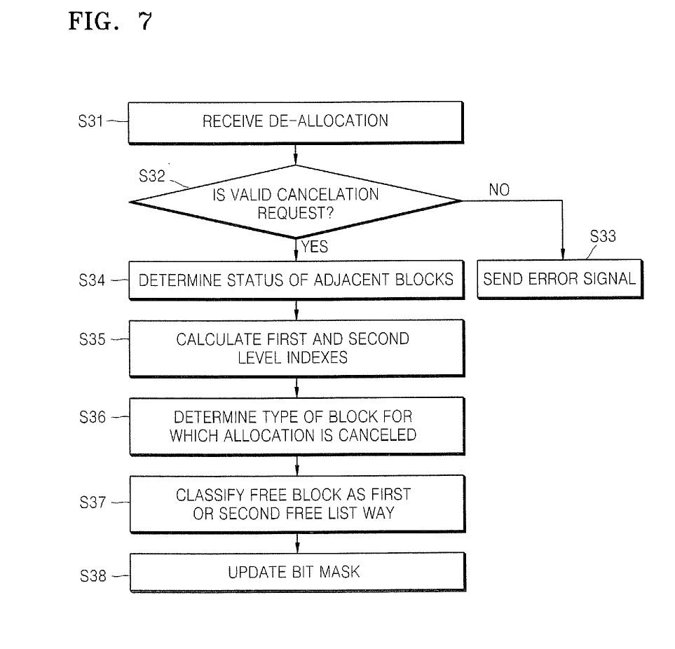

FIG. 7 is a flowchart illustrating a memory de-allocation operation according to an embodiment of the present invention.

Referring to FIG. 7, in operation S31, a memory de-allocation request is received. Operation S32 next determines whether the de-allocation request concerns a valid object by using a doubly linked list relating to various pieces of pointer information. If the allocation request does not concern the valid object, operation S33 sends an error message.

In operation S34, the status of physically adjacent blocks is determined based on the doubly linked list in response to the memory de-allocation request. If there is one free block or there are two free blocks in the adjacent blocks as a result of the determination, a corresponding free block and free blocks adjacent to the corresponding free block are coalesced to form a large free block. The formed free block is inserted into a free list way, which is identified by using the newly formed block's size and block type. Meanwhile, if there is no adjacent free block, a corresponding free block (a block for which memory de-allocation is requested) is inserted into a free list way, which is identified by using the deallocated block's size and block type. To insert the corresponding free block into particular free list classes and sets, indexes of a free list class and a free list set corresponding to the block of which allocation is freed (or the coalesced block) are calculated in operation S35 by using the lookup table TB1. In operation S36, the type of the block for which allocation is canceled (or the combined block) is determined based on information about block type. As a result of determination, the corresponding free block is classified in operation S37 as a first free list way or a second free list way. In operation S38, first through third level masks are updated by using information (about the size and type of the block) obtained from the previous operations according to the memory free of the corresponding block. The indexes of free list class and free list set may be calculated by using algorithm below.

[Algorithm 3]

```
BitShift = 24;
Byte = BlkSize >> BitShift;
first-level-index = LTB1[Byte];
While(first-level-index == 0xFF){
    BitShift += −8;
Byte = (BlkSize >> BitShift) && 0XFF;
    first-level-index = LTB1[Byte];
    }
first-level-index += BitShift;
second-level-index = (BlkSize >> (first-level-index − 3))&7;
```

If the allocation of a block is canceled, the lifespan of the block may be determined and a bit value of a prediction mask may be updated according to a result of the determination. The lifespan of the block may be determined by the number of other blocks that are allocated between the allocation and the de-allocation of the predetermined block. In more detail, if a great number of blocks are allocated between the allocation and the de-allocation of the predetermined block, the block may be determined to be long-lived. To the contrary, if a few number of blocks are allocated between the allocation and the de-allocation of the predetermined block, the block may be determined to be short-lived. The prediction mask may be updated by using algorithm below.

[Algorithm 4]

```
Blk_LifeTime = Global_Alloc_BlkNum- Alloc_BlkNum;
if(Blk_LifeTime< (Blk_Max_LifeTime/2)){
    ModeCnt[Class]++;}
else{
    ModeCnt[Class]−−;
    Max_Span_In-Blks= MAX(Max_Span_In-Blks, Blk_LifeTime);}
if(ModeCnt[Class]> 0){
    BlkPredMask  = BlkPredMask  /(1 << Class);} // Class is
    short-lived
else{
    BlkPredMask  = BlkPredMask  & (0xFFFFFFFF  \hat{ } (1 << Class));}
    // Class is long-lived
```

As shown in algorithm 4 above, the lifespan of the block is computed as the number of other blocks that are allocated between the allocation and the de-allocation of the predetermined block. The lifespan of a corresponding block is compared with the maximum lifespan value that is initially established as a predetermined value. For example, the lifespan of the corresponding block is compared with a half of the maximum lifespan value Blk_Max_LiftTime. According to a result of the comparison, if the lifespan of the corresponding block is smaller than half of the maximum lifespan value Blk_Max_LiftTime, a mode count ModeCnt may be increased by 1, and if the lifespan of the corresponding block is greater than half of the maximum lifespan value Blk_Max_LiftTime, the mode count ModeCnt may be reduced by 1. If the corresponding block belongs to an N^{th} free list class, the value of the N^{th} bit of the prediction mask Pred_Mask may be set to 1 or 0 based on the value of the mode count ModeCnt. Meanwhile, if the lifespan of the corresponding block is greater than the maximum lifespan value Blk_Max_LiftTime, the lifespan of the corresponding block may be updated to the maximum lifespan value Blk_Max_LiftTime.

In view of the operation of updating the prediction mask Pred_Mask, in the present embodiment, the prediction mask Pred_Mask predicts the lifespan of an object for which memory allocation is requested based on the size of the object and statistics of blocks included in a predetermined free list class as well. For example, when it is assumed that blocks having sizes a, b, and d are short-lived and blocks having a size c are long-lived, among the blocks having the sizes a, b, c, and d included in the N^{th} free list class, if the short-lived blocks having the sizes a, b, and d are more frequently allocated than the long-lived blocks having the size c and thus the value of the mode count ModeCnt is greater than a predetermined value, the N^{th} free list class may have a bit value of 1. To the contrary, if the long-lived blocks having the size c are more frequently allocated than the short-lived blocks having the sizes a, b, and d and thus the value of the mode count ModeCnt is smaller than the predetermined value, the N^{th} free list class may have a bit value of 0.

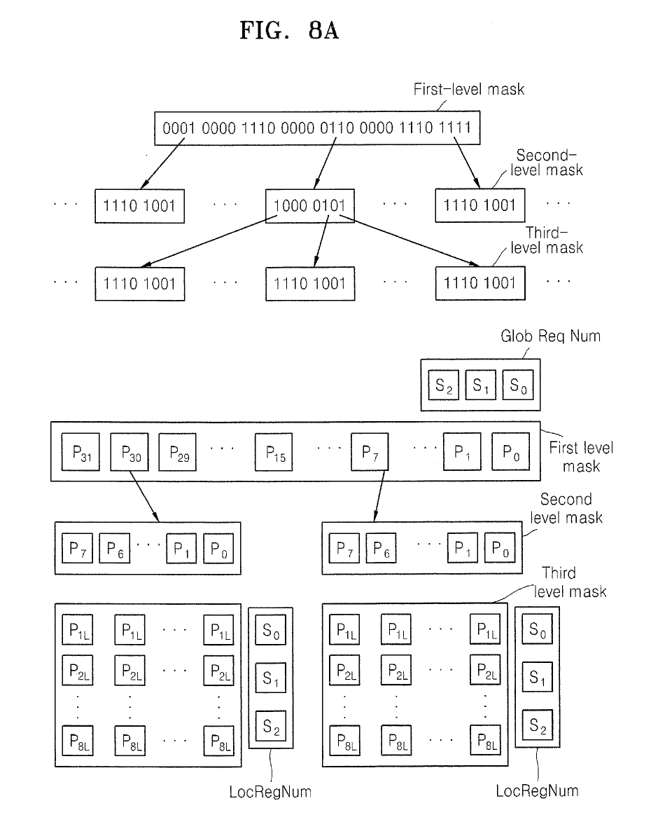

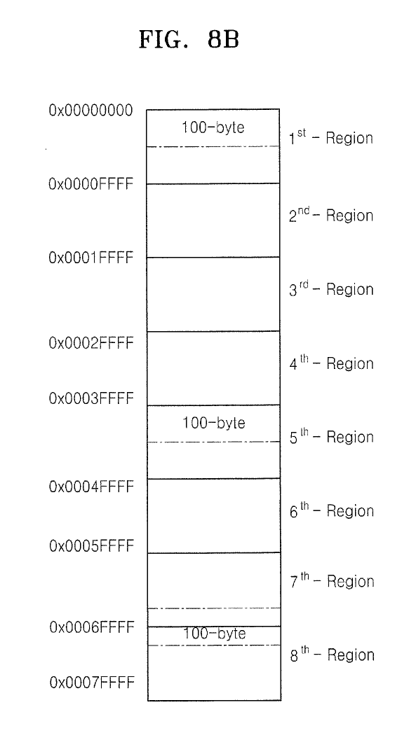

FIGS. 8A and 8B illustrate the bitmasks, free lists, and heap organization in an embedded system according to another embodiment of the present invention. Referring to FIGS. 8A and 8B, a memory managing unit included in the embedded system uses a plurality of free lists. A heap memory may be virtually divided into a plurality of regions. Each free list has a size within a predetermined region and manages free blocks positioned in one of the regions of the heap memory.

A plurality of levels of masks is used to hierarchically divide a plurality of free lists. The free lists are classified as a plurality of free list classes and each free list class is divided into a plurality of free list sets. Each free list set is further divided into a plurality of free list ways. The free list corresponding to one of the free list ways manages free blocks included in one of the regions of the heap memory. Therefore, if the heap memory is divided into N regions, one of the free list sets may be divided into N free list ways.

Referring to FIG. 8A, bit masks of three levels may be used to discriminate free blocks included in one of the regions of the heap memory and a predetermined range of size. For example, if free lists are classified as 32 free list classes, a mask including a 32 bit field may be used as a first level mask. Each bit of the first level mask indicates whether a corresponding free list class includes available free blocks. Each free list class may be divided into a plurality of sets. Each bit of the first level mask may correspond to a second level mask of 8 bits so that 32 second level masks can be used to determine whether each free list set may include an available free block.

Each free list set may be divided into a plurality of free list ways. For example, if the heap memory is divided into 8 regions, each free list set may be divided into 8 free list ways. Therefore, each free list corresponding to each free list way has a size within a predetermined range and includes information about a free block included in one of the 8 regions of the heap memory. For example, referring to FIG. 8B, assume a block of size 100 bytes is classified as a predetermined free list class and free list set, and three free blocks of size 100 bytes each are available in the 1^{st}, 5^{th}, and 7^{th} regions of the heap memory. In this case, the 1^{st}, 5^{th}, and 7^{th} free list ways, respectively, keep the free blocks that are located in the 1^{st}, 5^{th}, and 7^{th} regions of the heap memory.

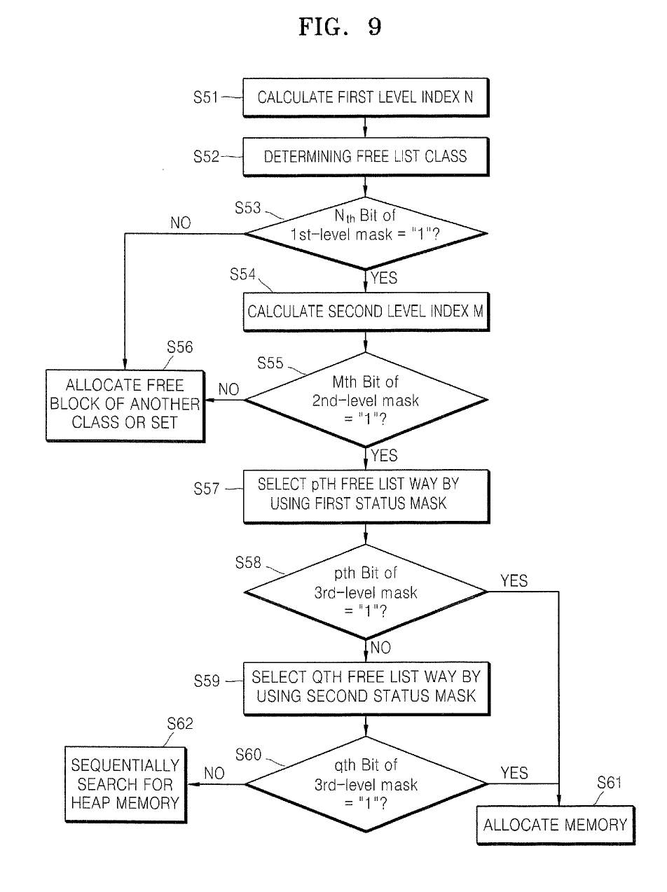

FIG. 9 is a flowchart illustrating a memory allocation operation performed by the embedded system shown in FIG. 8B according to an embodiment of the present invention. In the present embodiment, free lists are classified as 32 free list classes, each free list class is divided into 8 free list sets, and each set includes 8 free list ways.

If a memory allocation request is received, in operation S51, a first level index is calculated based on the size of an object for which memory allocation is requested. The first level index may be calculated in a similar manner as described in the previous embodiment so that a memory managing unit may include the lookup table TB1 used to calculate the first level index.

In operation S52, one of a plurality (e.g., 32) of free list classes may be selected according to the calculation of the first level index. After an N^{th} free list class is selected by the first level index, a first level mask is used in operation S53 to determine whether the N^{th} free list class includes an available free block. If the N^{th} free list class is determined to include the available free block, the first level index is established as N, and in operation S54, a second level index may be established as a value of a predetermined number of bits of the object. Such operation may be performed in the same manner as described in the previous embodiment.

If the second level index is calculated as M, operation S55 determines whether an M^{th} free list set of the N^{th} free list class includes an available free block. Such operation may be performed by using a second level mask. If the N^{th} class does not include the available free block or free list sets included in the N^{th} class do not include the available free block, the memory allocation operation may be performed by using an algorithm similar to that used in the previous embodiment.

In the present embodiment, the memory managing unit 111 maintains spatial locality among the blocks which are allocated recently and the blocks which are similar in size. In order to maintain local properties between the blocks, information about regions of a memory in which blocks have been recently allocated may be tracked by using a first status mask GlobRegNum, and information about regions of the memory in which the blocks having similar sizes have been allocated may be tracked by a plurality of second status masks LocRegNum. The second status mask LocRegNum is used to track information about the memory region from which free blocks have been allocated recently at each free list set level. For instance, if a heap memory is divided into 8 regions, the first status mask GlobRegNum and each second status mask LocRegNum may have 3 bits. The first status mask GlobRegNum and the second status masks LocRegNum may be included in the memory managing unit as shown in FIG. 8A. The first status mask GlobRegNum may be globally used, and the second status masks LocRegNum may be locally used.

In the present embodiment, free blocks are allocated by using the process below.

If the first level index and the second level index are calculated, a corresponding free list set is selected by using the second level mask. In operation S57, a predetermined free list way (one of a plurality of free list ways included in the selected free list set) is selected using the first status mask GlobRegNum. In operation S58, it is determined whether the selected free list way indexed by the first status mask GlobRegNum includes an available free block by using a third level mask. If a top free block of free blocks corresponding to the predetermined free list way is greater than the size of the object for which memory allocation is requested, in operation S61, the top free block is used for the requested block.

If the predetermined free list way indexed by the first status mask GlobRegNum does not include the available free block, a free list way indexed by the second status masks LocRegNum is selected in operation S59, and operation S60 determines whether the selected free list way includes an available free block. If the selected free list way is determined to include the available free block and a top free block of the free blocks corresponding to the selected free list way is greater than the size of the object for which memory allocation is requested, operation S61 is performed. However, if there is no free block in the free list way indexed by the second status masks LocRegNum, the regions of the heap memory are sequentially searched in operation S62. A first free list way including the available free block is used for the requested memory block. According to the allocation of the free block, the first status mask GlobRegNum and the second status masks LocRegNum that include information of allocation of recent memory are updated.

A memory allocation cancellation (or memory free) operation of the present embodiment is performed in a similar manner as described in the previous embodiment. During the memory allocation cancellation operation, a combination of memory may generate a greater size of a free block, thereby calculating indexes of free list classes and free list sets corresponding to the free block based on the size of the free block. The free block is included in one of the free list ways based on indexes of the free list ways. For example, if a heap memory includes 8 virtual memory regions, three upper bits of an address of the memory block may indicate information about the 8 memory regions. The free block is inserted into one of the free list ways based on the information of memory region.

While the inventive concept has been particularly shown and described with reference to exemplary embodiments thereof, it will be understood that various changes in form and details may be made therein without departing from the spirit and scope of the following claims.

What is claimed is:

1. A method of managing a dynamic memory, the method comprising:
predicting whether an object for which memory allocation is requested is a short-lived first type object or a long-lived second type object by using index information relating to the size of the object;
determining whether a heap memory includes a free block that is to be allocated to the object by using a plurality of free lists that are classified as a plurality of hierarchical levels; and
allocating the free block to the object if the heap memory is determined to include the free block,
wherein, if the object is predicted to be the first type object, the free block is allocated to the object in a first direction in the heap memory, and, if the object is predicted to be the second type object, the free block is allocated to the object in a second direction in the heap memory.

2. The method of claim 1, wherein the plurality of free lists are classified as a plurality of free list classes having relatively large sizes, each free list class is divided into a plurality of free list sets having relatively small sizes, and each free list set is further divided into a plurality of free list ways used to allocate the free block to the first type object or the second type object.

3. The method of claim 2, wherein predicting the type of the object is performed by using a prediction mask including bit information about an object type of each free list class, and
wherein determining whether the heap memory includes the free block is performed by using a first level mask including bit information indicating whether each free list class includes an available free block, a second level mask including bit information indicating whether each free list set includes an available free block, and a third level mask including bit information indicating whether each free list way includes an available free block.

4. The method of claim 2, further comprising:
responding to the free list class or free list set being determined not to include the free block by performing memory allocation to determine whether a higher free list class or free list set than that corresponding to the object includes the free block and/or determining whether the free block is included in a region of the heap memory that is allocated to a different type of an object from a predicted type of the object.

5. The method of claim 1, further comprising: de-allocating the memory with regard to the object in response to a memory de-allocation request with regard to the object,
wherein de-allocating the memory comprises:
updating the bit information of the first level mask through the third level mask based on information about the size and type of the block for which de-allocation is requested; and
detecting the number of other blocks for which memory allocation is performed between the memory allocation and de-allocation to determine the lifespan of the block and updating the prediction mask based on the result of the detection.

6. The method of claim 1, wherein the free block is split into multiple free blocks in response to the size of the free block exceeding the size of the object for which memory allocation is requested.

7. The method of claim 1, wherein a memory allocation request for memory smaller than a predetermined size is separated from other memory requests.

8. A method of managing a dynamic memory, the method comprising:
determining whether a heap memory that is divided virtually into a plurality of regions includes a free block that is allocated to an object by using a plurality of free lists that are classified as a plurality of hierarchical levels based on sizes of a plurality of free blocks;
dividing a lower hierarchical level of the plurality of hierarchical levels into a plurality of free list ways corresponding to the number of the plurality of regions of the heap memory, and selecting one of the free list ways by using at least one status mask including information about a recently allocated region among the plurality of regions of the heap memory; and
in response to the selected free list way including an available free block, allocating a corresponding region of the heap memory to the object.

9. The method of claim 8, wherein the plurality of free lists are classified as a plurality of free list classes having relatively large sizes, each free list class is divided into a plurality of free list sets having relatively small sizes, and each free list set is further divided into the plurality of free list ways.

10. An embedded system that dynamically allocates memory in response to a memory allocation request, the embedded system comprising:
an embedded processor controlling an operation of the embedded system, and comprising a memory managing unit controlling dynamic memory allocation in response to the memory allocation request of an application; and
a memory unit allocating memory to an object for which memory allocation is requested under the control of the embedded processor,
wherein the memory managing unit determines whether the memory unit includes a free block that is allocated to the object by using a plurality of free lists that are classified as a plurality of hierarchical levels based on sizes of a plurality of free blocks.

11. The embedded system of claim 10, wherein the memory managing unit predicts whether an object for which memory allocation is requested is a short-lived first type object or a long-lived second type object by using index information relating to the size of the object, and responds to the object being predicted to be the first type object by allocating the free block to the object in a first direction in the heap memory, and responds to the object being predicted to be the second type object by allocating the free block to the object in a second direction in the heap memory.

12. The embedded system of claim 10, wherein the memory unit includes a plurality of regions,
wherein the plurality of free lists are classified as a plurality of first hierarchical levels having relatively large sizes, each first hierarchical level is divided into a plurality of second hierarchical levels having relatively small sizes, and each second hierarchical level is divided into a plurality of third hierarchical levels corresponding to the number of the plurality of regions of the memory unit, and
wherein the memory managing unit selects one of the plurality of regions of the memory unit by using at least one status mask including information about a recently allocated region among the plurality of regions of the heap memory and performs a memory allocation operation according to a result of determining whether the selected region includes a free block.
